(19) United States
(12) Patent Application Publication
(10) Pub. No.: US 2008/0182523 A1
(43) Pub. Date: Jul. 31, 2008

(54) RADIO

(75) Inventor: Takehiko Toyoda, Yokohama-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/013,560

(22) Filed: Jan. 14, 2008

(30) Foreign Application Priority Data
Jan. 16, 2007 (JP) 2007-007250

(51) Int. Cl. H04B 17/00

(52) U.S. Cl. 455/67.14

(57) ABSTRACT

A radio has a test signal generating portion, an orthogonal modulator for, provided with a first electric signal of a first frequency, transforming the test signal at the first frequency and outputting it as a modulated signal, a first amplifier for amplifying the modulated signal, a second amplifier, capable of inputting the modulated signal frequency-converted by using a difference frequency signal indicating a frequency difference between the first electric signal and a second electric signal of a second frequency and the amplified modulated signal, for amplifying the inputted modulated signal, an orthogonal demodulator for, provided with the second electric signal, transforming the modulated signal at the second frequency and outputting it as a demodulated signal, and an analysis portion for, provided with the demodulated signal and the test signal, analyzing characteristics of at least one of the orthogonal modulator and the orthogonal demodulator.

### CROSS REFERENCE TO RELATED APPLICATIONS

This application is based upon and claims the benefit of priority from the prior Japanese Patent Application No. 2007-7250, filed on Jan. 16, 2007, the entire contents of which are incorporated herein by reference.

### BACKGROUND OF THE INVENTION

The present invention relates to a radio.

Conventionally, in the case of conducting a test of analog circuits such as a DA (digital-analog) converter circuit and an AD (analog-digital) converter circuit built into a semiconductor integrated circuit, a test pattern is inputted to the DA converter circuit and the AD converter circuit from an external test apparatus so as to determine quality of a function by comparing a signal outputted from each of them with expected value data. However, there has been a problem that an expensive test apparatus is required in order to generate the test pattern and determine quality, which increases production costs.

To solve such a problem, there has been a proposal of a semiconductor integrated circuit with the DA converter circuit, the AD converter circuit and an FFT circuit built into it, capable of performing characteristic evaluation of the DA converter circuit and the AD converter circuit by having the FFT circuit analyze output wherein an analog test signal is inputted to the DA converter circuit and DA-converted and that converted output is inputted to the AD converter circuit and AD-converted (refer to Japanese Patent Laid-Open No. 2004-48383 for instance). As the proposal does not require an expensive test apparatus to be prepared outside, the production costs can be reduced.

However, such a semiconductor integrated circuit performs an analysis by DA-converting a signal which is an AD-converted analog test signal. Therefore, there is a problem that although the semiconductor integrated circuit can evaluate AD conversion and DA conversion, it cannot evaluate characteristics of a modulation circuit in a transmitting portion and a demodulating circuit in a receiving portion of an LSI for radio communication which performs simultaneous transmission and reception (duplex communication) by a scheme such as an FDD (Frequency Division Duplex).

### SUMMARY OF THE INVENTION

According to one aspect of the present invention, there is provided a radio comprising:

a first oscillator for generating and outputting a first electric signal of a first frequency;

a second oscillator for generating and outputting a second electric signal of a second frequency;

a test signal generating portion for outputting a test signal;

an orthogonal modulator for, provided with the test signal and the first electric signal, transforming the test signal at the first frequency and outputting it as a modulated signal of the first frequency;

a first amplifier for amplifying and outputting the modulated signal;

a second amplifier, capable of inputting the modulated signal frequency-converted by using a difference frequency signal indicating a frequency difference between the first electric signal and the second electric signal and the amplified modulated signal, for amplifying and outputting the inputted modulated signal;

an orthogonal demodulator for, provided with the modulated signal outputted from the second amplifier and the second electric signal, transforming the modulated signal at the second frequency and outputting it as a demodulated signal of the second frequency; and

an analysis portion for, provided with the demodulated signal and the test signal, analyzing characteristics of at least one of the orthogonal modulator and the orthogonal demodulator.

According to one aspect of the present invention, there is provided a radio comprising:

a first oscillator for generating and outputting a first electric signal of a first frequency;

a second oscillator for generating and outputting a second electric signal of a second frequency;

a switch for, provided with the first electric signal and the second electric signal, outputting one of them;

a test signal generating portion for outputting a test signal;

an orthogonal modulator for, provided with the test signal and the second electric signal via the switch, transforming the test signal at the second frequency and outputting it as a modulated signal of the second frequency;

a first amplifier for amplifying and outputting the modulated signal;

a second amplifier for, provided with the modulated signal outputted from the first amplifier, amplifying and outputting it;

an orthogonal demodulator for, provided with a modulated signal outputted from the second amplifier and the second electric signal, transforming the modulated signal at the second frequency and outputting it as a demodulated signal of the second frequency; and

an analysis portion for, provided with the demodulated signal and the test signal, analyzing characteristics of at least one of the orthogonal modulator and the orthogonal demodulator.

According to one aspect of the present invention, there is provided a radio comprising:

a first oscillator for generating and outputting a first electric signal of a first frequency;

a second oscillator for generating and outputting a second electric signal of a second frequency;

a switch for, provided with the first electric signal and the second electric signal, outputting one of them;

a test signal generating portion for outputting a test signal;

an orthogonal modulator for, provided with the test signal and the first electric signal, transforming the test signal at the first frequency and outputting it as a modulated signal of the first frequency;

a first amplifier for amplifying and outputting the modulated signal;

a second amplifier for, provided with the modulated signal outputted from the first amplifier, amplifying and outputting it;

an orthogonal demodulator for, provided with a modulated signal outputted from the second amplifier and the first electric signal via the switch, transforming the modulated signal at the first frequency and outputting it as a demodulated signal of the first frequency; and

an analysis portion for, provided with the demodulated signal and the test signal, analyzing characteristics of at least one of the orthogonal modulator and the orthogonal demodulator.

### BRIEF DESCRIPTION OF THE DRAWINGS

FIG. 1 is a diagram showing a skeleton framework of a radio according to a first embodiment of the present invention;

FIG. 2 is a diagram showing a skeleton framework of a radio according to a second embodiment of the present invention;

FIG. 3 is a diagram showing a skeleton framework of a radio according to a third embodiment of the present invention;

FIG. 4 is a diagram showing the skeleton framework of the radio according to a variation;

FIG. 5 is a diagram showing the skeleton framework of the radio according to a variation;

FIG. 6 is a diagram showing the skeleton framework of the radio according to a variation; and

FIG. 7 is a diagram showing the skeleton framework of the radio according to a variation.

### DESCRIPTION OF THE EMBODIMENTS

Hereafter, a radio according to embodiments of the present invention will be described based on the drawings.

### First Embodiment

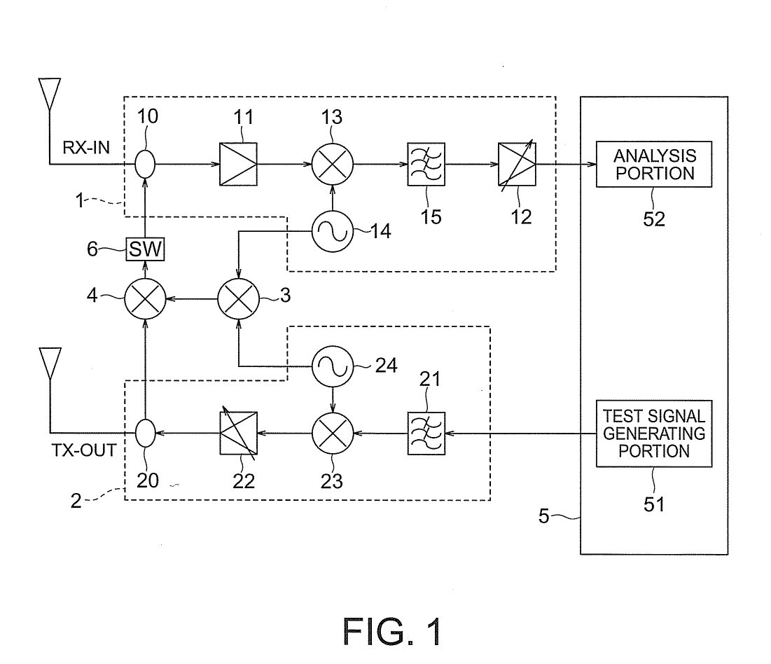

FIG. 1 shows a skeleton framework of the radio according to the first embodiment of the present invention. Without special limitation, the radio is provided to a mobile communication terminal which renders multimedia information transmittable, such as a W-CDMA (Wideband-Code Division Multiple Access) terminal. According to the DS-CDMA/FDD (Direct-Sequence-CDMA/Frequency-Division Duplex) scheme of the W-CDMA terminal, transmission and reception operate simultaneously during communication with different transmit and receive frequencies.

The radio includes a receiving circuit 1, a transmitting circuit 2, mixers 3 and 4, a test portion 5 and a switch 6. The receiving circuit 1 includes an input terminal 10, amplifiers 11 and 12, an orthogonal demodulator 13, a voltage control oscillator 14 and a low-pass filter 15. The transmitting circuit 2 includes an output terminal 20, a low-pass filter 21, an amplifier 22, an orthogonal modulator 23 and a voltage control oscillator 24. The test portion 5 includes a test signal generating portion 51 and an analysis portion 52, and exerts on-off control over the switch 6. The switch 6 is turned on only when testing the receiving circuit 1 and the transmitting circuit 2.

A signal given to the transmitting circuit 2 has high-band noise reduced by the low-pass filter 21. Although only a path of one signal line is shown here, orthogonal I-ch and Q-ch signal lines may also be included. The orthogonal modulator 23 transforms a signal outputted from the low-pass filter 21 at a frequency of a signal outputted from the voltage control oscillator 24 so as to output a modulated signal. The modulated signal is amplified by the amplifier 22 and outputted via the output terminal 20.

The signal received by the radio is inputted to the receiving circuit 1. The received signal is inputted to the low noise amplifier 11 via the input terminal 10. The orthogonal demodulator 13 transforms a signal amplified by the low noise amplifier 11 at a frequency of a signal outputted from the voltage control oscillator 14 so as to output a demodulated signal. The demodulated signal has high-frequency band noise reduced by the low-pass filter 15 and is amplified by the amplifier 12 to be outputted from the receiving circuit 1.

The mixer 3 is given the signals outputted from the voltage control oscillators 14 and 24, and generates and outputs a difference frequency signal which indicates a frequency difference between them. In the case where the frequency of the signal outputted from the voltage control oscillator 14 is f1 and the frequency of the signal outputted from the voltage control oscillator 24 is f2 (<f1), the frequency of the difference frequency signal is f1−f2. For instance, in the case where the frequency of the signal received by the radio is 2140 MHz and the frequency of the signal to be transmitted is 1950 MHz, 2140 MHz (=f1) is oscillated from the voltage control oscillator 14 and 1950 MHz (=f2) is oscillated from the voltage control oscillator 24. The difference frequency between them (frequency of the signal outputted from the mixer 3) is 190 MHz.

In the case of evaluating operating characteristics of the receiving circuit 1 and the transmitting circuit 2 of the radio, a test signal is outputted from the test signal generating portion 51 and inputted to the transmitting circuit 2. The test signal transformed at the frequency f2 and amplified by the transmitting circuit 2 is given to the mixer 4.

The mixer 4 is given the test signal outputted from the transmitting circuit 2 (frequency f2) and the difference frequency signal (frequency f1−f2) outputted from the mixer 3, and frequency-converts (upconverts) the test signal to output it. Thus, the frequency of the test signal outputted from the mixer 4 is f1 (=f1−f2+f2). The signal outputted from the mixer 4 is given to the receiving circuit 1 as the test signal via the switch 6. The test signal amplified and demodulated by the receiving circuit 1 is given to the analysis portion 52.

The analysis portion 52 compares the signal outputted from the receiving circuit 1 with expected value data of the test signal outputted from the test signal generating portion 51 and propagating through the transmitting circuit 2 and the receiving circuit 1 so as to evaluate the operating characteristics of the receiving circuit 1 and the transmitting circuit 2. The analysis portion 52 evaluates the characteristics by measuring an EVM (Error Vector Magnitude) and a BER (Bit Error Rate) for instance.

With such a configuration, the signal orthogonally modulated by the transmitting circuit 2 can be rendered as the test signal of the receiving circuit 1. Moreover, a difference frequency is generated between an oscillating frequency of the voltage control oscillator 14 in the receiving circuit 1 and an oscillating frequency of the voltage control oscillator 24 in the transmitting circuit 2. And the test signal which has propagated through the transmitting circuit 2 is frequency-converted by using the difference frequency. Thus, the receiving circuit 1 can be given a modulated test signal of the same frequency as the signal to be actually received by the radio.

As no external test apparatus is used, test time and test costs can be reduced. Moreover, the orthogonally modulated signal is the test signal of the receiving circuit so that evaluation can be performed as to the operating characteristics of modulation in the transmitting circuit 2 and demodulation in the receiving circuit 1.

Thus, the radio of this embodiment can evaluate the characteristics of a modulation circuit and a demodulating circuit without using an external test apparatus so that it can reduce production costs.

### Second Embodiment

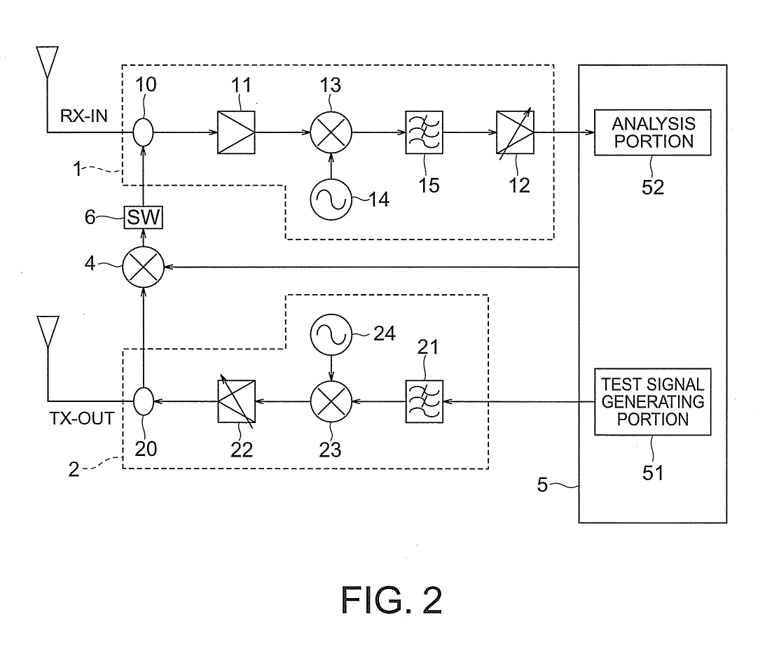

FIG. 2 shows a skeleton framework of the radio according to the second embodiment of the present invention. The same portions as FIG. 1 are given the same symbols. As the operation of the receiving circuit 1, the transmitting circuit 2 and the analysis portion 52 is the same as the first embodiment, a description thereof will be omitted.

According to the first embodiment, the difference frequency signal of the signals outputted from the voltage control oscillators 14 and 24 was generated. However, this embodiment has a configuration for outputting a signal equivalent to the difference frequency signal from the test portion 5. The signal is generated from a clock signal given to the test portion 5.

With such a configuration, there is no need to provide the mixer for generating the difference frequency signal so that circuit area can be reduced. However, it should be noted that it is difficult to generate the difference frequency signal in the test portion 5 in the case where the frequency difference between the signals transmitted and received by the radio is large (difference between the oscillating frequencies of the voltage control oscillators 14 and 24 is large).

The radio of this embodiment can evaluate the characteristics of a modulation circuit and a demodulating circuit without using an external test apparatus and thereby reduce production costs. It can also reduce the circuit area.

### Third Embodiment

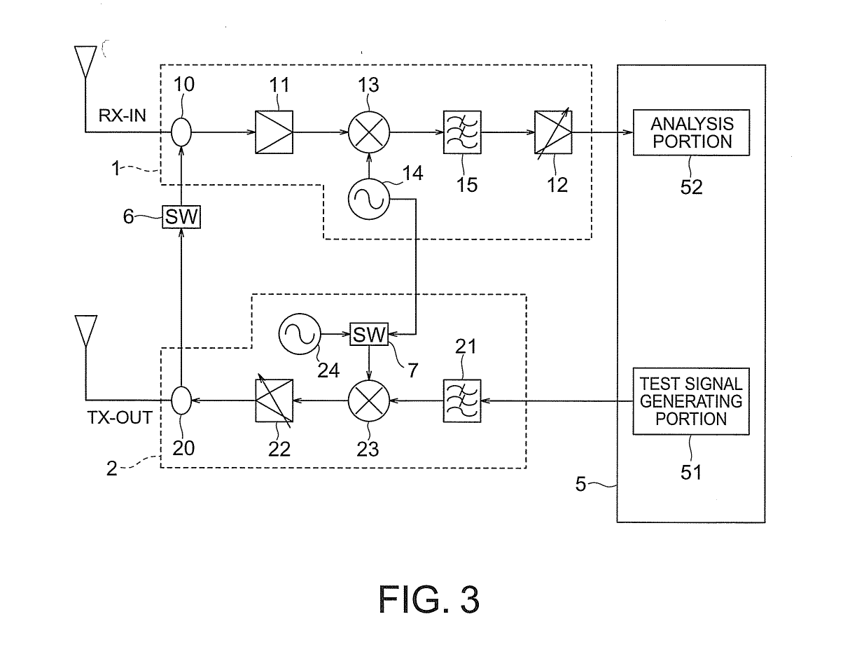

FIG. 3 shows a skeleton framework of the radio according to the third embodiment of the present invention. The same portions as FIG. 1 are given the same symbols. As the operation of the receiving circuit 1, the transmitting circuit 2 and the analysis portion 52 is the same as the first embodiment, a description thereof will be omitted.

According to the first embodiment, the difference frequency signal of the signals outputted from the voltage control oscillators 14 and 24 was generated. And the test signal which has propagated through the transmitting circuit 2 was frequency-converted by using the difference frequency signal. Thus, the frequency of the test signal inputted to the receiving circuit 1 was rendered as the frequency of the signal received by the radio (oscillating frequency of the voltage control oscillator 14). According to this embodiment, however, a switch 7 is provided, where the switch 7 is switched over when orthogonally modulating the test signal with the orthogonal modulator 23 so as to transform it at the oscillating frequency of the voltage control oscillator 14 and generate a modulated signal.

Switching control of the switch 7 is exerted by the test portion 5. The switching control is exerted over the switch 7 so that the orthogonal modulator 23 is given the oscillating frequency of the voltage control oscillator 24 when the radio is in operation and given the oscillating frequency of the voltage control oscillator 14 when testing the receiving circuit 1 and the transmitting circuit 2.

With such a configuration, there is no need to provide the mixer for generating the difference frequency signal (mixer 3 of FIG. 1) and the mixer for performing frequency conversion (mixer 4 of FIG. 1) so that circuit area can be reduced.

The radio of this embodiment can evaluate the characteristics of a modulation circuit and a demodulating circuit without using an external test apparatus and thereby reduce production costs. It can also reduce the circuit area.

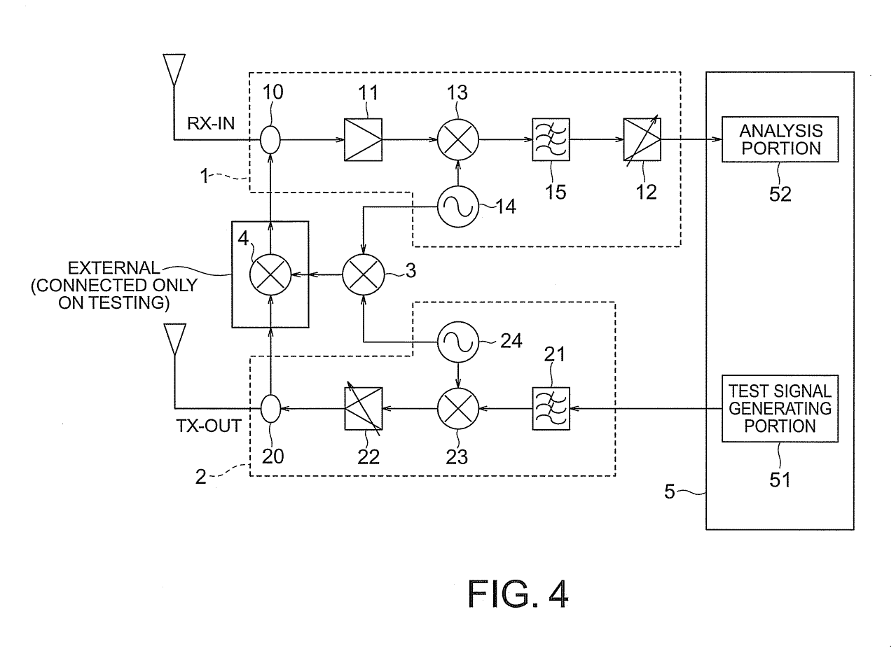

As shown in FIG. 4, it is also possible to have a configuration wherein the mixer 4 is external and is connected when testing the receiving circuit 1 and the transmitting circuit 2.

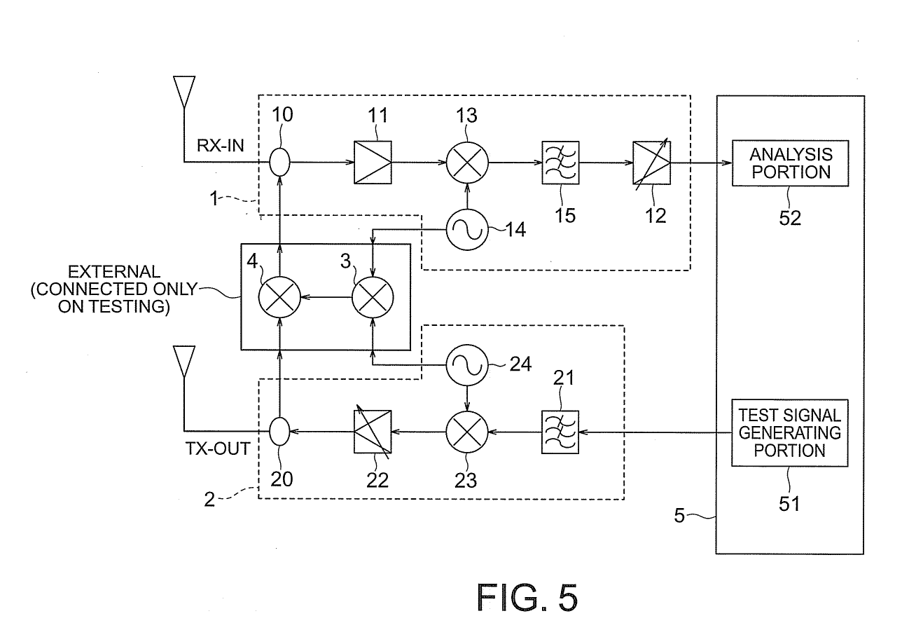

Similarly, as shown in FIG. 5, it is also possible to have a configuration wherein the mixers 3 and 4 are external and are connected when testing the receiving circuit 1 and the transmitting circuit 2.

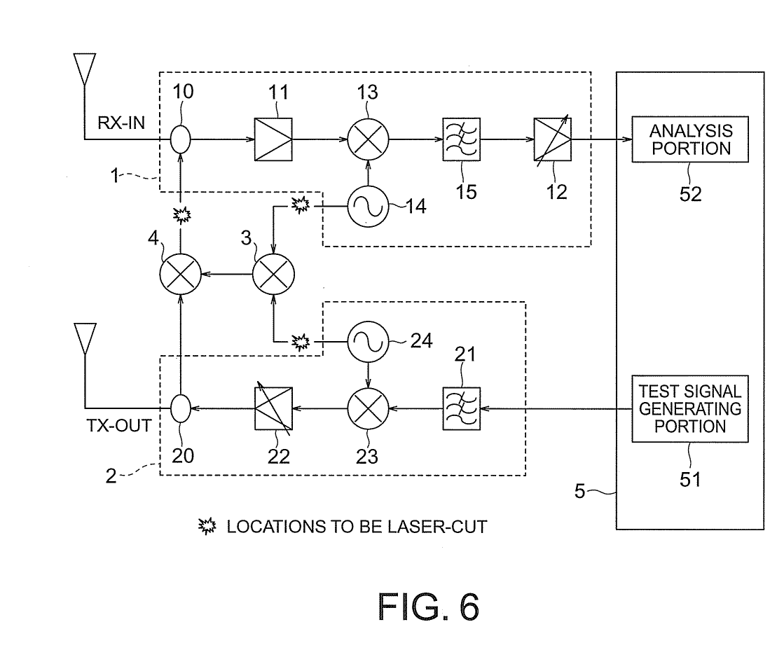

Moreover, as shown in FIG. 6, wiring connecting the voltage control oscillators 14 and 24 with the mixer 3 may be laser-cut in order to take isolation after testing the receiving circuit 1 and the transmitting circuit 2.

In the case of rendering the mixers 4 and 3 external or laser-cutting the wiring after the testing, there is no need to provide the switch 6.

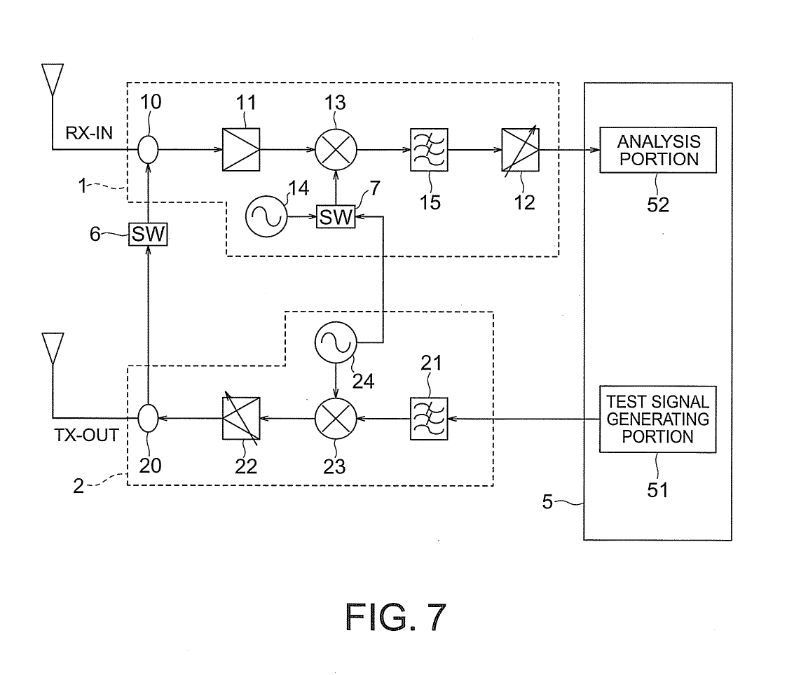

According to the third embodiment, the test signal was orthogonally modulated at the oscillating frequency of the voltage control oscillator 14. However, as shown in FIG. 7, the switch 7 may also be provided to orthogonally demodulate the test signal at the oscillating frequency of the voltage control oscillator 24. It is also possible to evaluate demodulation characteristics of the receiving circuit 1 with such a configuration.

It is also possible, before conducting the test by inputting the above test signal modulated by the transmitting circuit 2 to the receiving circuit 1, to once analyze the output of the transmitting circuit 2 with the external test apparatus and then input the modulated test signal to the receiving circuit 1 so as to perform analysis in the analysis portion 52.

The external test apparatus determines whether or not the modulation is normally performed by the orthogonal modulator 23 based on frequency distribution of received output signals of the transmitting circuit 2. It also simply determines whether or not the amplifier 22 is normally operating based on power.

Thus, the radio can be tested under the condition that the transmitting circuit 2 is normally operating. Therefore, it is possible to determine which of the transmitting circuit 2 and the receiving circuit 1 has a failure.

It is also possible to output the test signal (sine-wave signal) to the receiving circuit 1 from the external test apparatus and simply check whether the receiving circuit 1 is normally operating by analyzing the output of the receiving circuit 1 in the analysis portion 52 so as to conduct the test thereafter by inputting the test signal modulated by the transmitting circuit 2 to the receiving circuit 1.

It is also possible to simply check the operation of each of the receiving circuit 1 and the transmitting circuit 2 by using the external test apparatus and conduct the test thereafter by inputting the test signal modulated by the transmitting circuit 2 to the receiving circuit 1.

Here, the external test apparatus has only to detect the frequency distribution and power of the output of the transmitting circuit 2 or output the test signal (sine-wave signal). Therefore, a high-performance test apparatus is not required.

It is also possible to render as external circuitry the test signal generating portion 51 provided to the test portion 5 for outputting the test signal (single-frequency sine-wave signal for instance) instead of building it into the radio. In the case of rendering the test signal generating portion 51 external, test signal information is given to the analysis portion 52.

What is claimed is:

1. A radio comprising:
a first oscillator for generating and outputting a first electric signal of a first frequency;
a second oscillator for generating and outputting a second electric signal of a second frequency;
a test signal generating portion for outputting a test signal;
an orthogonal modulator for, provided with the test signal and the first electric signal, transforming the test signal at the first frequency and outputting it as a modulated signal of the first frequency;
a first amplifier for amplifying and outputting the modulated signal;
a second amplifier, capable of inputting the modulated signal frequency-converted by using a difference frequency signal indicating a frequency difference between the first electric signal and the second electric signal and the amplified modulated signal, for amplifying and outputting the inputted modulated signal;
an orthogonal demodulator for, provided with the modulated signal outputted from the second amplifier and the second electric signal, transforming the modulated signal at the second frequency and outputting it as a demodulated signal of the second frequency; and
an analysis portion for, provided with the demodulated signal and the test signal, analyzing characteristics of at least one of the orthogonal modulator and the orthogonal demodulator.

2. The radio according to claim 1, further comprising:
a first mixer for, provided with the amplified modulated signal outputted from the first amplifier and the difference frequency signal, performing frequency conversion, generating the modulated signal of the second frequency and outputting it to the second amplifier.

3. The radio according to claim 2, wherein the difference frequency signal is generated and outputted by a test portion including the test signal generating portion and the analysis portion.

4. The radio according to claim 2, further comprising:
a second mixer for, provided with the first electric signal and the second electric signal, generating the difference frequency signal and outputting it to the first mixer.

5. The radio according to claim 4, wherein there is electrical separation between the first oscillator and the second mixer and between the second oscillator and the second mixer.

6. The radio according to claim 2, wherein there is electrical separation between the first mixer and the second amplifier.

7. A radio comprising:
a first oscillator for generating and outputting a first electric signal of a first frequency;
a second oscillator for generating and outputting a second electric signal of a second frequency;
a switch for, provided with the first electric signal and the second electric signal, outputting one of them;
a test signal generating portion for outputting a test signal;
an orthogonal modulator for, provided with the test signal and the second electric signal via the switch, transforming the test signal at the second frequency and outputting it as a modulated signal of the second frequency;
a first amplifier for amplifying and outputting the modulated signal;
a second amplifier for, provided with the modulated signal outputted from the first amplifier, amplifying and outputting it;
an orthogonal demodulator for, provided with a modulated signal outputted from the second amplifier and the second electric signal, transforming the modulated signal at the second frequency and outputting it as a demodulated signal of the second frequency; and
an analysis portion for, provided with the demodulated signal and the test signal, analyzing characteristics of at least one of the orthogonal modulator and the orthogonal demodulator.

8. A radio comprising:
a first oscillator for generating and outputting a first electric signal of a first frequency;
a second oscillator for generating and outputting a second electric signal of a second frequency;
a switch for, provided with the first electric signal and the second electric signal, outputting one of them;
a test signal generating portion for outputting a test signal;
an orthogonal modulator for, provided with the test signal and the first electric signal, transforming the test signal at the first frequency and outputting it as a modulated signal of the first frequency;
a first amplifier for amplifying and outputting the modulated signal;
a second amplifier for, provided with the modulated signal outputted from the first amplifier, amplifying and outputting it;
an orthogonal demodulator for, provided with a modulated signal outputted from the second amplifier and the first electric signal via the switch, transforming the modulated signal at the first frequency and outputting it as a demodulated signal of the first frequency; and
an analysis portion for, provided with the demodulated signal and the test signal, analyzing characteristics of at least one of the orthogonal modulator and the orthogonal demodulator.
